(19) United States
(12) Patent Application Publication
(10) Pub. No.: US 2007/0281273 A1
(43) Pub. Date: Dec. 6, 2007

(54) DENTAL HANDPIECE

(76) Inventor: Derek Turner, Ottawa (CA)

Correspondence Address: Charles N. J. Ruggiero;Ohlandt, Greeley, Ruggiero & Perle, L.L.P., 10th Floor, One Landmark Square, Stamford, CT, 06901-2682, US

(21) Appl. No.: 11/751,134

(22) Filed: May 21, 2007

(30) Foreign Application Priority Data
Nov. 24, 2004 (CA) 2488454
Nov. 24, 2005 (CA) PCT/CA05/01782

(51) Int. Cl. A61C 1/05

(52) U.S. Cl. 433/132

(57) ABSTRACT

A dental handpiece is disclosed including a turbine construction creating a radial in flow of air onto the impeller blades about the whole circumference of the turbine. An air guide inserted into the turbine housing and extending about the turbine defines a drive air supply chamber separated from the turbine housing and communicating with a drive air supply conduit. The air guide has a plurality of inlet openings for radially inwardly directing pressurized air from the drive air supply chamber into the turbine housing onto the turbine.

### FIELD OF THE INVENTION

The present invention relates to handpieces for rotating tools and particularly to turbine driven medical or dental handpieces.

### BACKGROUND OF THE INVENTION

Numerous handpieces for rotating tools exist. Turbine driven handpieces are widely used in dental offices and medical labs around the world. Most handpieces include a handle portion, a connector at one end of the handle portion and a tool carrier drive head at the other end. The connector provides a connection of the handpiece to various air, water, light and power supply conduits, generally combined in a so called umbilical cord. The drive head houses a tool rotating assembly, generally composed of a tool mount or chuck, and a motor or turbine, rotatably mounted in the drive head for driving the chuck.

Various different types of turbine arrangements are in use, all of which include a turbine in a turbine housing, a supply of pressurized air into the housing for driving the turbine and a set of bearings for rotatably supporting the turbine in the housing and the drive head. Since conventional dental handpieces are constructed to rotate the dental drill or burr at speeds of up to 500,000 rpm, the bearings are subject to large stress. Furthermore, asymmetrical thrust generated by drive air impinging tangentially on the turbine places additional stress on the bearings. This problem is addressed in PCT Application No. CA2003/001999 which teaches a dental handpiece including a drive head construction creating a radial inflow of turbine drive air onto the impeller blades about the whole circumference of the turbine. An annular drive air supply chamber and air vanes, shown as machined or molded integral with the drive head, serve to direct the drive air from the drive air supply chamber radially inwardly onto the turbine. Thus, drive air is supplied evenly about the turbine, providing a self-centering of the turbine by the drive air. However such a vane configuration is relatively expensive to manufacture and may affect assembly techniques, and time. Thus a need remains for a simpler structure for directing the turbine drive air radially inwardly to the turbine or a structure that facilitates manufacturing or reduces assembly time of the handpiece, especially the drive head portion.

### SUMMARY OF THE INVENTION

It is an object of the present invention to obviate or mitigate at least one disadvantage of existing handpiece designs.

In a first aspect, the present invention provides a medical or dental turbine handpiece having a handle, a drive head attached to the handle and defining a turbine housing, a turbine rotatably received in the turbine housing and a drive air supply conduit for supplying pressurized drive air to the turbine housing, including an air guide inserted into the drive head and extending about the turbine for defining a drive air supply chamber separated from the turbine housing and communicating with the drive air supply conduit, the air guide having a plurality of inlet openings for radially inwardly directing pressurized air from the drive air supply chamber into the turbine housing and onto the turbine. Preferably, the handpiece of further includes a drive air exhaust conduit for receiving drive air from the turbine housing, wherein the air guide further defines a drive air exhaust chamber separated from the turbine housing and communicating with the drive air exhaust conduit, the air guide further having a plurality of exhaust openings for allowing drive air to flow from the turbine housing into the drive air exhaust conduit.

Preferably, the drive air supply chamber is an annular chamber extending substantially coaxially about the axis of rotation of the turbine. Preferably, the drive air exhaust chamber is an annular chamber extending substantially coaxially about the axis of rotation of the turbine. Preferably, the air guide is a generally cylindrical air ring substantially circumscribing the axis of rotation of the turbine. Preferably, the inlet openings are shaped inlet openings. Preferably, the exhaust openings are shaped exhaust openings. Preferably, the air guide is adapted to be removable from the drive head. Preferably, the plurality of inlet openings are evenly distributed about the axis of rotation of the turbine. Preferably, the plurality of exhaust openings are evenly distributed about the axis of rotation of the turbine. Preferably, the plurality of inlet openings and the plurality of exhaust openings are staggered with respect to one another. Preferably, the plurality of exhaust openings have a cross-sectional area larger than that of the plurality of inlet openings.

Preferably, the shaped inlet openings form nozzles. Preferably, the nozzles are adapted to accelerate the drive air prior to said air impinging on the turbine. Preferably, at least one of the plurality of inlet openings is adapted to direct the turbine drive air onto the turbine in a generally radially inward direction towards the direction of rotation of the turbine. Preferably, the inlet openings are substantially circular. Preferably, the exhaust openings are substantially circular.

In another aspect, the present invention provides a drive head for a medical or dental turbine handpiece defining a turbine housing adapted to rotatably receive a turbine, and a lower bearing and an upper bearing and adapted to connect to a drive air supply conduit for supplying pressurized drive air to the turbine housing, said drive head including a generally cylindrically shaped housing, having a substantially closed lower end and a substantially open upper end, and a progressively increasing bore extending from the closed end to the open end, wherein the drive head further including an air guide shoulder interposed between the lower end and the upper end adapted to receive an air guide for defining a drive air supply chamber separated from the turbine housing and communicating with the drive air supply conduit, the air guide having a plurality of openings for radially inwardly directing pressurized air from the drive air supply chamber into the turbine housing and onto the turbine.

In another aspect, the present invention provides an air guide for a medical or dental turbine handpiece having a handle, a drive head attached to the handle and defining a turbine housing, a turbine rotatably received in the turbine housing and a drive air supply conduit for supplying pressurized drive air to the turbine housing, said air guide including a substantially cylindrical ring adapted to extend about the turbine for defining a drive air supply chamber separated from the turbine housing and communicating with the drive air supply conduit, the air guide having a plurality of inlet openings for radially inwardly directing pressurized drive air from the drive air supply chamber into the turbine housing and onto the turbine. Preferably, the medical or dental handpiece further includes a drive air exhaust conduit for receiving drive air from the turbine and the air guide further includes a substantially cylindrical ring adapted to extend about the turbine for defining a drive air exhaust chamber separated from the turbine housing and communicating with the drive air exhaust conduit, the air guide having a plurality of exhaust openings adapted to allow drive air to flow from the turbine into the drive air exhaust conduit.

Preferably, the air guide includes an inlet portion having the inlet openings and an outlet portion having the outlet openings. Preferably, the inlet portion and the outlet portion are of unitary construction or separate component. Preferably, the inlet openings are shaped inlet openings. Preferably, the exhaust openings are shaped exhaust openings. Preferably, the air guide is adapted to be removable from the drive head. Preferably, the plurality of inlet openings are evenly distributed about the axis of rotation of the turbine. Preferably, the plurality of exhaust openings are evenly distributed about the axis of rotation of the turbine. Preferably, the plurality of inlet openings and the plurality of exhaust openings are staggered with respect to one another. Preferably, the plurality of exhaust openings have a cross-sectional area larger than that of the plurality of inlet openings. Preferably the shaped inlet openings form nozzles. Preferably the nozzles are adapted to accelerate the drive air prior to said air impinging on the turbine. Preferably, at least one of the plurality of inlet openings is adapted to direct the turbine drive air onto the turbine in a generally radially inward direction towards the direction of rotation of the turbine. Preferably, the inlet openings are substantially circular. Preferably, the exhaust openings are substantially circular.

In another aspect, the invention provides a method of assembling a rotary tool drive head having a lower bearing, a turbine, an air guide, an upper bearing, and a closure, including the steps, in sequence, of providing a drive head having a turbine housing having a generally cylindrically shaped housing bore having an at least substantially closed end and an open end, and further including a lower bearing shoulder proximate to the closed end adapted to receive a lower end bearing, an air guide shoulder displaced axially towards the open end from the lower end bearing shoulder, said air guide shoulder adapted to receive the air guide, said air guide shoulder having a perimeter greater than the lower bearing shoulder, and said air guide adapted to receive an upper bearing; inserting the lower bearing into the housing bore through the open end of the housing; inserting the air guide or turbine into the housing bore through the open end of the housing; inserting the other of the air guide or the turbine into the housing bore through the open end; inserting the upper bearing into the housing bore through the open end of the head; and closing the open end with the closure. Preferably, the lower bearing, the air guide, the turbine, and the upper bearing are individually inserted into the housing bore in succession from the open end of the housing. The air guide and the turbine and the upper bearing may be pre-assembled into a sub-assembly and then the said sub-assembly is inserted into the housing bore through the open end of the housing.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of one embodiment of a dental handpiece in accordance with the present invention;

FIG. 2 illustrates the shape and design of a drive head casing of one embodiment of a handpiece in accordance with the invention;

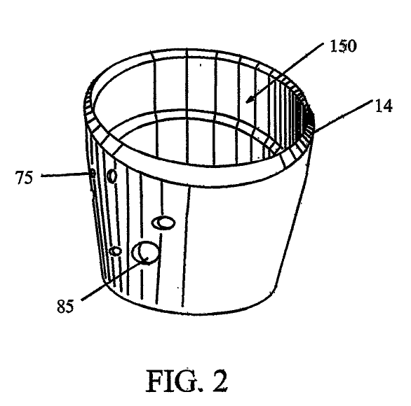

FIG. 3a-c shows top, side, and cross-section views of the drive head casing of one embodiment of a handpiece in accordance with the invention, FIG. 3c showing a cross-section through the drive head casing taken along the line A-A in FIG. 3b;

FIG. 4 shows an axial cross-section through the drive head of one embodiment of a handpiece in accordance with the invention;

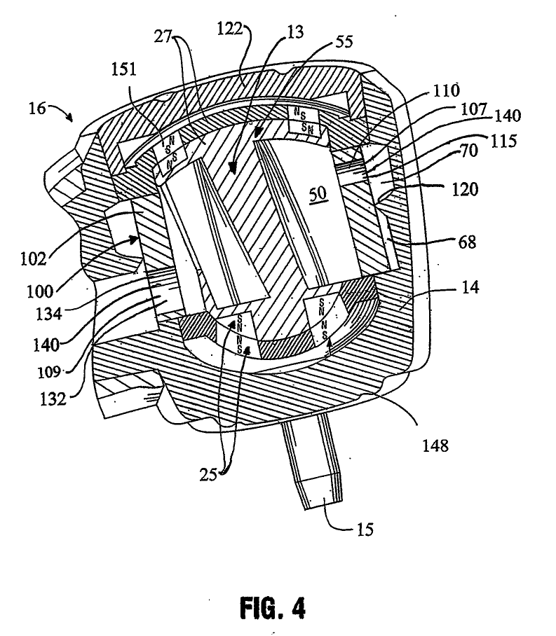

FIG. 5a-c shows front, cross-section, and bottom views of a turbine in one embodiment of a handpiece in accordance with the invention, FIG. 5b showing a cross-section through the turbine taken along the lines A-A in FIG. 5a;

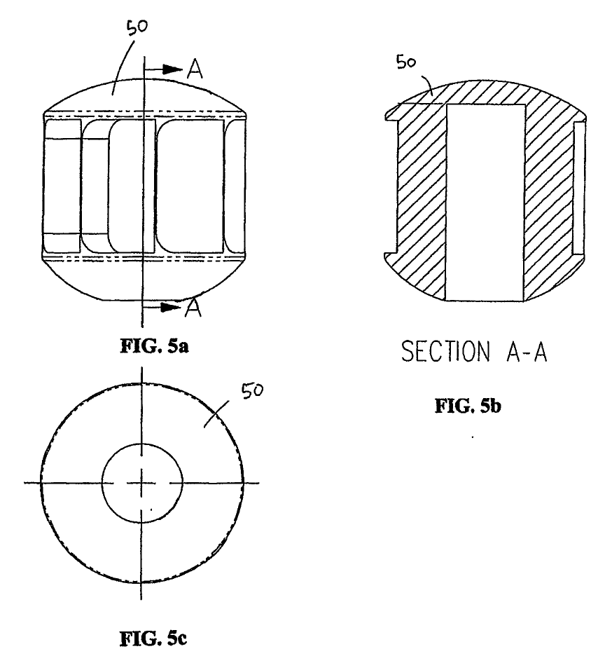

FIG. 6 illustrates a perspective view of an air guide of one embodiment of a handpiece in accordance with the invention; and

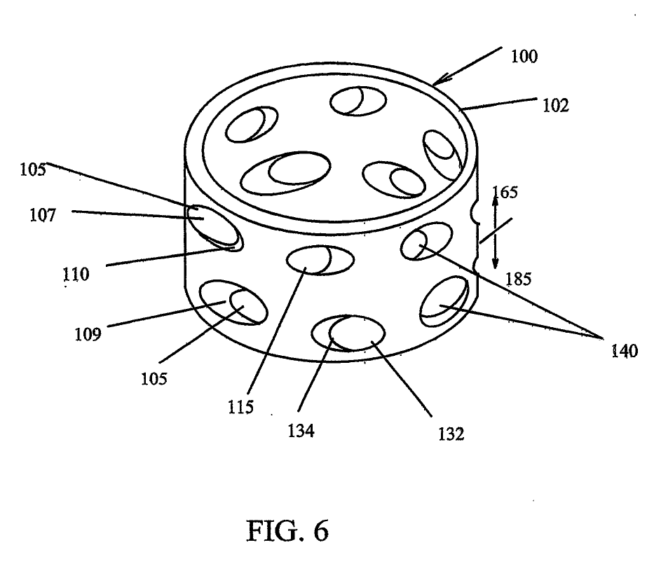

FIG. 7 shows a side view of an air guide of one embodiment of a handpiece in accordance with the invention.

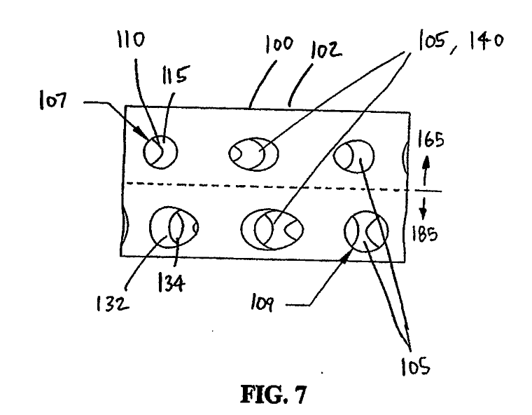

### DETAILED DESCRIPTION

Generally, the present invention provides a handpiece for a rotatable tool 15 and in particular a medical or dental handpiece 10 and a method of assembling the handpiece. Although for the sake of simplicity reference is made in the following to a dental handpiece, all structural and functional features of the invention are equally applicable to medical handpieces and other handpieces for supporting high speed rotating tools.

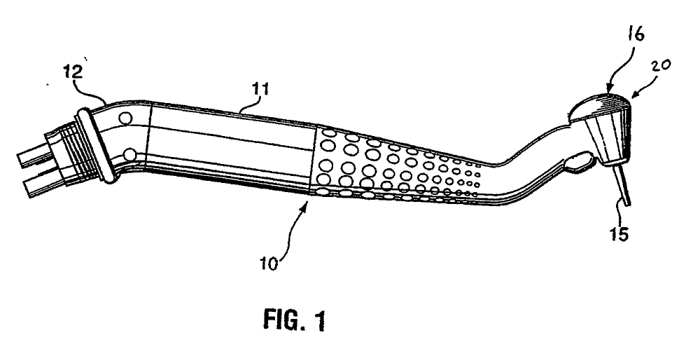

As is apparent from FIG. 1, one embodiment of the dental handpiece 10 in accordance with the invention includes a stem/handle portion 11, a plug-in connection 12 for linkage with an umbilical cord (not shown) which, among other things, provides pressurized turbine drive air through a drive air supply conduit 75 and removes turbine drive air exhaust through a drive air exhaust conduit 85, and a drive head 16 with a drive unit 20 for rotatably supporting and driving a rotatable tool 15.

Drive Unit

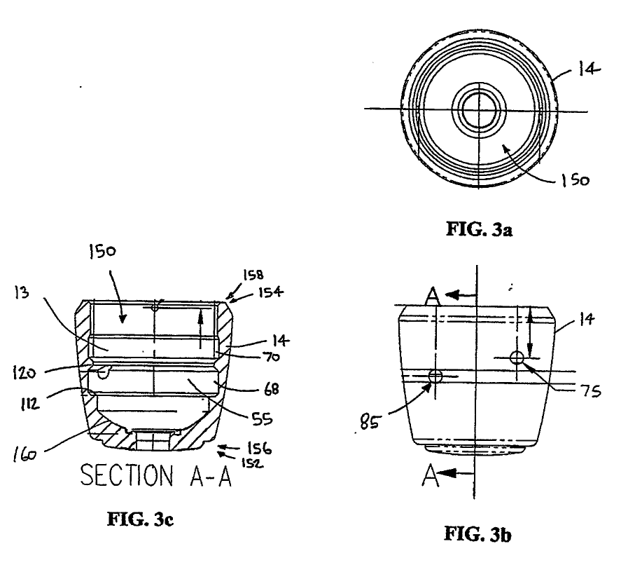

The drive unit 20 of the dental handpiece 10 in accordance with the invention generally includes a turbine 50 (FIGS. 3a-c) which is supported in a turbine housing 13 defined by a drive head casing 14. The radial air flow turbine design requires that the drive air be supplied to the turbine 50 radially inwardly rather than tangentially. This is achieved in the illustrated embodiment in accordance with the invention by providing an air guide 100 inserted into the drive head casing 14 to define an annular drive air supply chamber 70 separated from the turbine housing 13 and communicating with the drive air supply conduit 75. The drive air supply chamber 70 extends concentrically about the axis of rotation of the turbine 50.

Air Guide

In a preferred embodiment, the air guide 100 is inserted into the drive head casing 14 about the turbine 50 to define the annular drive air supply chamber 70 and preferably also an annular drive air exhaust chamber 68. The air guide 100 sealingly engages the drive head casing 14 and preferably other components of drive head 16 to seal the drive air supply chamber 70 from the turbine chamber 55. Pressurized drive air is supplied to the turbine 50 from the drive air supply chamber 70 via openings 105 in the air guide 100.

Drive air from the drive air supply chamber 70 is directed by the air guide 100 radially into the turbine chamber 55 for impact with the impeller of the turbine 50. Exhaust air from the turbine 50 is directed by the air guide 100 from the turbine chamber 55 to the drive air exhaust chamber 68. In the preferred embodiment, the air guide 100 is in the form of an air ring 102 and is fittingly received in the drive head casing 14 to form the annular drive air supply chamber 70 and an annular drive air exhaust chamber 68. The air guide 100 includes an inlet portion 165 and an exhaust portion 185. Preferably the inlet portion 165 and the exhaust portion 185 are attached, or more preferably integral, but the inlet portion 165 and the exhaust portion 185 may be separate components and may differ in many ways, such as configuration or geometry. The drive head casing 14 may omit the exhaust portion 185 of the air guide 100 and be adapted to allow the drive air to flow directly from the turbine chamber 55 to the drive air exhaust chamber 68.

Preferably the air ring 102 sealingly engages an air guide shoulder 112 and a divider 120 of the drive head casing 14 to form the annular drive air exhaust chamber 68. Although the divider 120 is shown formed with the drive head casing 14, the divider 120 may be a separate component or components, may be formed with the air guide 100 or may be of any other configuration well known in the art to provide a drive air supply chamber 70 in cooperation with the air guide 100. An upper bearing 27 having an upper bearing stator 151 sealingly engages the air ring 102 to form the annular drive air inlet chamber 70. Although the inlet is shown above the outlet, one skilled in the art could appreciate that they could be reversed.

A plurality of openings 105 in the form of inlet openings 107, preferably shaped inlet openings 110 in the air ring 102 at least at two spaced-apart locations distributed about the axis of rotation direct turbine drive air from the annular drive air supply chamber 70 to radially impinge upon the turbine 50 in the turbine chamber 55. The shaped inlet openings 110 may form nozzles 115 which direct or accelerate the drive air. A plurality of exhaust openings 109 in the form of shaped exhaust openings 132 in the air ring 102 at least at two spaced-apart locations distributed about the axis of rotation permit turbine drive air to pass from the turbine chamber 55 to the drive air exhaust chamber 68. The shaped exhaust openings 132 may form nozzles 134 which direct or accelerate the drive air.

The shaped inlet openings 110 and shaped exhaust openings 132 are collectively referred to herein as the shaped openings 140. Preferably the air ring 102 includes a multiplicity of shaped openings 140. More preferably the shaped openings 140 are evenly distributed about the axis of rotation of the turbine 50. Preferably, the shaped openings 140 are distributed about the axis of rotation of the turbine 50 in a pair of staggered rows, with one row forming the shaped inlet openings 110 and the other row forming the shaped exhaust openings 132. The shaped openings 140 may be of any desired shape to achieve the desired air flow, direction, aerodynamics and hydraulics. Preferably the shaped openings 140 are generally circular. Preferably the cross-sectional area of the exhaust openings 109 is greater than the cross-sectional area of the inlet openings 107. The larger cross-section (for example by a larger diameter if the exhaust openings 109 and the inlet openings 107 are substantially circular) provides reduced back pressure to the turbine 50. Preferably the shaped openings 140 have a diameter of between about 0.043″ to about 0.055″. Preferably the inlet portion 165 of the air ring 102 includes eight shaped openings 140 as shaped inlet openings 110 having a diameter of about 0.043″. Preferably the exhaust portion 185 of the air ring 102 includes eight shaped openings 140 as shaped exhaust openings 132 having a diameter of about 0.055″.

The shaped openings 140 may form a passage orthogonal to the surface of the air ring 102 or may be directed in at least one direction. Preferably, the shaped openings 140 are directed at least partially tangential with respect to the turbine 50. Preferably the shaped inlet openings 110 are directed at an angle at least partially in the direction of rotation of the turbine 50. Preferably the shaped exhaust openings 132 are directed at an angle at least partially in the direction opposite to the direction of rotation of the turbine 50.

Preferably the air ring 102 is non-rotatably fixed in place by attachment to the drive head casing 14, for example by a friction fit, adhesive, or other means known in the art. However, preferably, the air ring 102 is removable from the drive head casing 14. The air ring 102 may be constructed of any suitable material. Preferably, the air ring 102 is constructed of 316 stainless steel.

Progressive Cavity Drive Head

In a preferred embodiment, the drive head casing 14 is configured to have a progressive cavity bore 150 having a cross-section which progressively increases from a closed end 152 (bottom end 156) through to an open end 154 (top end 158). Preferably, the closed end 152 of the drive head casing 14 is integrally formed with the drive head casing 14, forming a generally cup-shaped drive head casing 14. However, the closed end 152 of the drive head casing 14 may be detachably fixed to the drive head casing 14, such as by a screwed, welded, adhesive, or other connection. As illustrated, the bottom end 156 of the drive head casing 14 is shown to be the closed end 152 and the top end 158 shown to be the open end 154, but it would be readily apparent to one skilled in the art that the bottom end 156 could be the open end and that the top end 158 could be closed, with the cross-section of the bore 150 progressively increasing from the closed end to the open end.

The bore 150 may be generally tapered or preferably have a stepped change in cross-section. Preferably, a lower bearing shoulder 160 receives a lower bearing stator 148 of a lower bearing 25, and an air guide shoulder 112 receives the air ring 102. The upper bearing stator 151 is supported by the air ring 102, and a closure in the form of a cap 122 seals the drive head casing 14. The progressive cavity bore 150 allows the assembly of the drive head casing 14 to be effected through the open end 154 in a simple and straightforward sequential manner. With the cap 122 removed, the lower bearing stator 148 may be inserted into the bore 150 through the open end 154 to rest on the lower bearing shoulder 160, followed by the air ring 102 or turbine 50. Preferably the air ring 102 is installed, followed by the turbine 50. The upper bearing stator 151 is inserted and the drive head casing 14 closed by the installation of the cap 122. Alternatively, the lower bearing stator 148, the air ring 102, the turbine 50, and the upper bearing stator 151 are pre-assembled to form a sub-assembly, which is then inserted into the bore 150 through the open end 154, and then installing the cap 122.

The above-described embodiments of the present invention are intended to be examples only. Alterations, modifications and variations may be effected to the particular embodiments by those of skill in the art without departing from the scope of the invention, which is defined solely by the claims appended hereto.

1. A medical or dental turbine handpiece having a handle, a drive head attached to the handle and defining a turbine housing, a turbine rotatably received in the turbine housing and a drive air supply conduit for supplying pressurized drive air to the turbine housing, comprising:
an air guide inserted into the drive head and extending about the turbine for defining a drive air supply chamber separated from the turbine housing and communicating with the drive air supply conduit, the air guide having a plurality of inlet openings for radially inwardly directing pressurized air from the drive air supply chamber into the turbine housing and onto the turbine.

2. The handpiece of claim 1, further comprising a drive air exhaust conduit for receiving drive air from the turbine housing, wherein the air guide further defines a drive air exhaust chamber separated from the turbine housing and the drive air supply chamber and communicating with the drive air exhaust conduit, the air guide further having a plurality of exhaust openings for allowing drive air to flow from the turbine housing into the drive air exhaust conduit.

3. (canceled)

4. The handpiece of claim 2, wherein the drive air exhaust chamber is an annular chamber extending substantially coaxially about the axis of rotation of the turbine.

5. The handpiece of claim 2, wherein the air guide is a generally cylindrical air ring substantially circumscribing the axis of rotation of the turbine.

6. The handpiece of claim 1, wherein the inlet openings are shaped inlet openings for radially inwardly directing pressurized air from the drive air supply chamber onto the turbine.

7. (canceled)

8. The handpiece of claim 1, wherein the air guide is adapted to be removable from the drive head.

9. The handpiece of claim 1, wherein the plurality of inlet openings and the plurality of exhaust openings are evenly distributed about the axis of rotation of the turbine.

10. (canceled)

11. The handpiece of claim 2, wherein the plurality of inlet openings are staggered with respect to the plurality of exhaust openings.

12. The handpiece of claim 2, wherein the plurality of exhaust openings have a larger cross-sectional area than the plurality of inlet openings.

13. The handpiece of claim 1, wherein the shaped inlet openings form nozzles for accelerating the drive air prior to said air impinging on the turbine.

14. (canceled)

15. (canceled)

16. (canceled)

17. (canceled)

18. In a drive head for a medical or dental turbine handpiece defining a turbine housing and including a turbine rotatable supported in the turbine housing by a lower bearing and an upper bearing and a drive air supply conduit for supplying pressurized drive air to the turbine housing and a drive air exhaust conduit for removing spent drive air from the turbine housing, the drive head comprising:
a generally cylindrically shaped body with a substantially closed lower end and a substantially open upper end, and a progressively increasing bore extending from the closed end to the open end an air guide shoulder interposed between the lower end and the upper end for supporting an air guide as defined in claim 19 for defining together with the air guide an air chamber separated from the turbine housing, the air guide shoulder separating the air chamber into a drive air supply chamber communicating with the drive air supply conduit and a drive air exhaust chamber communicating with the drive air exhaust conduit.

19. An air guide for a medical or dental turbine handpiece having a handle, a drive head connected to the handle and defining a turbine housing, a turbine rotatably received in the turbine housing and a drive air supply conduit for supplying pressurized drive air to the turbine housing, said air guide comprising:
a substantially cylindrical sleeve adapted to extend concentrically about the turbine for defining a drive air supply chamber, the drive air supply chamber being separated from the turbine housing by the air guide and communicating with the drive air supply conduit, the air guide having a plurality of inlet openings for radially inwardly directing pressurized drive air from the drive air supply chamber into the turbine housing and onto the turbine.

20. The air guide of claim 19, wherein the medical or dental handpiece further includes a drive air exhaust conduit for receiving spent drive air from the turbine, wherein said air guide further defines a drive air exhaust chamber, the drive air exhaust chamber being separated from the turbine housing and communicating with the drive air exhaust conduit, the air guide having a plurality of exhaust openings adapted to allow spent drive air to flow from the turbine into the drive air exhaust conduit.

21. The air guide of claim 20, wherein the air guide comprises an inlet portion defining the drive air supply chamber and having the inlet openings and an outlet portion defining the drive air exhaust chamber and having the outlet openings.

22. (canceled)

23. The air guide of claim 21, wherein the inlet portion and the outlet portion are separate components.

24. (canceled)

25. (canceled)

26. The air guide of claim 19, adapted to be removeably insertable into the drive head.

27. The air guide of claim 19, wherein the plurality of inlet openings and the plurality of exhaust openings are evenly distributed about the axis of rotation of the turbine and the inlet openings are staggered with respect to the exhaust openings.

28. (canceled)

29. (canceled)

30. (canceled)

31. The air guide of claim 19, wherein the shaped inlet openings form nozzles for redirecting and accelerating the turbine drive air into the turbine housing and onto the turbine in a direction generally radially inward and in direction of rotation of the turbine.

32. (canceled)

33. (canceled)

34. (canceled)

35. (canceled)

36. A method of assembling a rotary tool drive head as comprising the steps, in sequence, of:
providing a drive head having a body defining a turbine housing with a generally cylindrically shaped bore, an at least substantially closed end and an open end, and further including a lower bearing shoulder proximate to the closed end for supporting a lower turbine bearing, an air guide shoulder displaced axially towards the open end from the lower end bearing shoulder, for supporting the air guide, said air guide shoulder having a perimeter greater than the lower bearing shoulder,
inserting the lower turbine bearing into the housing bore through the open end of the housing
inserting one of the air guide and turbine into the housing bore through the open end of the housing
inserting the other of the air guide and turbine into the housing bore through the open end
inserting an upper turbine bearing into the housing bore through the open end of the head, and
closing the open end with a closure.

37. (canceled)

38. The method of claim 36, wherein the lower bearing and the air guide and the turbine and the upper bearing are first pre-assembled into a sub-assembly and then the said sub-assembly is inserted into the housing bore through the open end of the housing.
